(19) United States
(12) Patent Application Publication
(10) Pub. No.: US 2008/0061169 A1
(43) Pub. Date: Mar. 13, 2008

(54) Steamer head

(75) Inventor: Steve A. Copeland, Barrie (CA)

Correspondence Address: SAND & SEBOLT, AEGIS TOWER, SUITE 1100, 4940 MUNSON STREET, NW, CANTON, OH, 44718-3615, US

(73) Assignee: RELIABLE CORPORATION, Toronto (CA)

(21) Appl. No.: 11/518,683

(22) Filed: Sep. 11, 2006

(51) Int. Cl. B05B 1/20

(52) U.S. Cl. 239/566; 239/525; 239/568; 239/754

(57) ABSTRACT

A steamer head for use with a steaming system for cleaning or smoothing fabric surfaces. The steamer head comprises a housing having a plurality of branches that extend between a base region and a front applicator face. The branches are disposed at an angle relative to each other so that they radiate outwardly from the base region in a fan shape. An inlet in a rear wall of housing is used to connect the steamer head to a hose extending outwardly from a remote steam-containing reservoir. An interior cavity is formed in the base region of the housing and is operationally connected to a bore in the inlet and thereby to the hose. Each of the branches includes a chamber that arises in the interior cavity and terminates in an outlet formed in the front applicator face. One or more of the branches and the chambers therein preferably are oriented so that they are disposed at an angle other than ninety degrees to the front applicator face. As a consequence, steam flowing from the hose, through the interior cavity and the chambers is emitted from the outlets at an angle other than ninety degrees to the front applicator face. The steam therefore fans outwardly away from the front applicator face.

### BACKGROUND OF THE INVENTION

1. Technical Field

This invention generally relates to steaming systems. More particularly, the invention relates to a steamer head for use with commercial and industrial steaming systems. Specifically, the invention relates to a steamer head that includes a plurality of branches which extend between a rear wall and a front applicator face and deliver steam from an inlet in the rear wall to outlets formed in the applicator face.

2. Background Information

Professional cleaners use steaming systems in commercial and industrial applications to clean furniture and carpets and to clean and smooth clothing and drapes. These steaming systems include a reservoir of water, a means for heating the water to produce steam and a hose to feed the steam to a steamer head. The steamer heads have an applicator face that is brought into contact with the surface to be cleaned or smoothed and a plurality of jets of steam are released through the applicator face and onto the surface.

The steamer heads used in commercial or industrial steaming systems are usually manufactured from aluminum for durability and so that they can withstand the 212° heat of the steam. The head typically comprises a housing that has an inlet at one end and the applicator face at the other end. The applicator face and inlet are separated from each other by a large interior chamber. Steam fed into the inlet in the head, via the hose, is shot under pressure through the interior chamber and exits the head through a plurality of holes formed in the applicator face. The holes may have small brass nozzles inserted into them and these nozzles are disposed substantially at right angles to the applicator face. Consequently, steam exiting the head through either the holes or the nozzles, tends to exit the head substantially at right angles to the applicator face. This means that the steam is projected directly outwardly from the face in a stream that is generally parallel to the longitudinal axis of the head.

Furthermore, in previously known steamer heads, the steam flows through the bore of the inlet and enters the large interior chamber of the head. The steam flows outwardly from the nearest available hole in the applicator face. Consequently, the rate and volume of steam that is emitted from the holes across the width of the applicator face tend not to be consistent. The holes that are positioned directly opposite the inlet tend to have the greatest rate and volume of steam exiting therefrom and the holes at the outermost side edges of the applicator face may have little to no steam exiting therefrom. This tends to result in only a fairly narrow effective steam swath coming into contact with the surface to be cleaned. So, for example, to steam drapes a professional cleaner will use a steamer head that has an applicator face that is approximately 4″ long. The steamer head is held a small distance away from the surface to be cleaned and is moved along the surface in several substantially parallel passes. However, the effective swath of steam emitted by previously known steamer heads should be approximately 4″ wide, but because the holes at the outermost edges of the applicator face emit little to no steam, the swath of steam emitted therefrom may be substantially less than 4″ wide. As a result, the professional cleaner has to overlap subsequent passes over the surface with the steamer head by a substantial amount to bring an effective amount of steam into contact with the surface. This need for substantially overlapping of the steamer head passes slows down the cleaning job and increases the amount of time the professional cleaner takes to finish the cleaning.

### SUMMARY OF THE INVENTION

The device of the present invention comprises a steamer head is used as part of a steaming system for cleaning or smoothing fabric surfaces such as carpeting, furniture, drapes or clothing. The steamer head comprises a housing having a plurality of branches that extend between a base region and a front applicator face. The branches are disposed at an angle relative to each other so that they radiate outwardly from the base region in a fan shape. An inlet in a rear wall of housing is used to connect the steamer head to a hose extending outwardly from a remote steam-containing reservoir. An interior cavity is formed in the base region of the housing and is operationally connected to a bore in the inlet and thereby to the hose. Each of the branches includes a chamber that arises in the interior cavity and terminates in an outlet formed in the front applicator face. One or more of the branches and the chambers therein may be oriented so that they are disposed at an angle other than ninety degrees to the front applicator face. As a consequence, steam flowing from the hose, through the interior cavity and the chambers preferably is emitted from the outlets at an angle other than ninety degrees to the front applicator face. The steam therefore preferably fans outwardly away from the front applicator face.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a steamer head in accordance with the present invention;

FIG. 2 is a side view of the steamer head of FIG. 1;

FIG. 3 is front end view of the steamer head with the head turned upside down to reveal the bottom surface thereof;

FIG. 4 is a bottom view of the steam head;

FIG. 5 is a cross-sectional view through line B-B of FIG. 4;

FIG. 6 is a rear view of the steamer head;

FIG. 7 is a front view of the steamer head;

FIG. 8 is a cross-section through line C-C of FIG. 7.

### DETAILED DESCRIPTION OF THE INVENTION

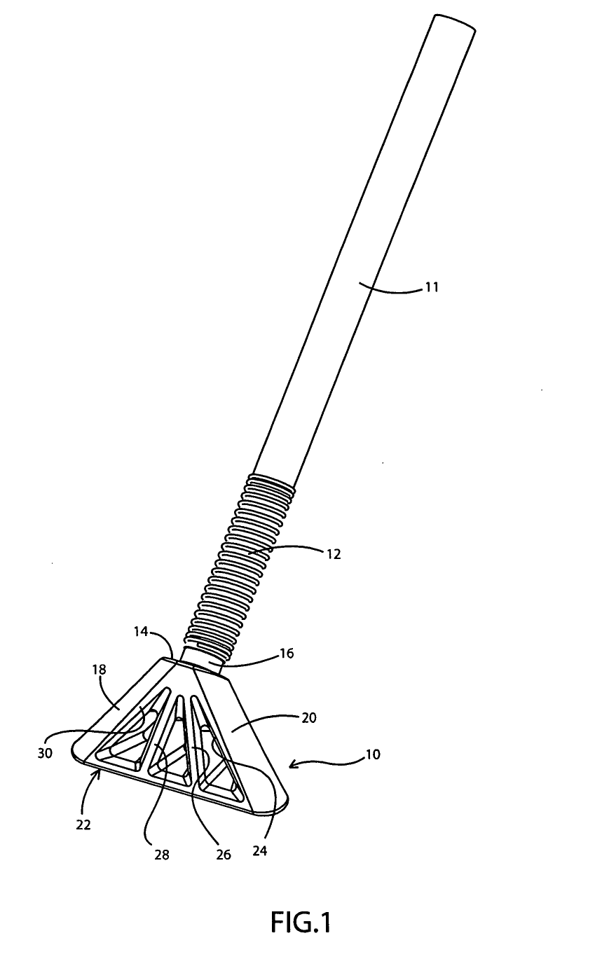

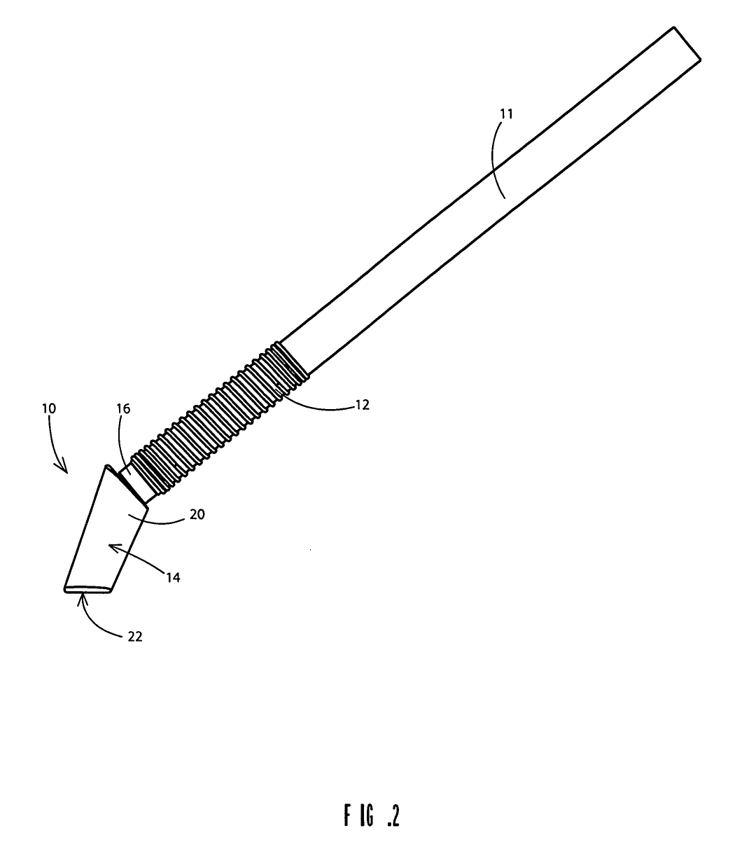

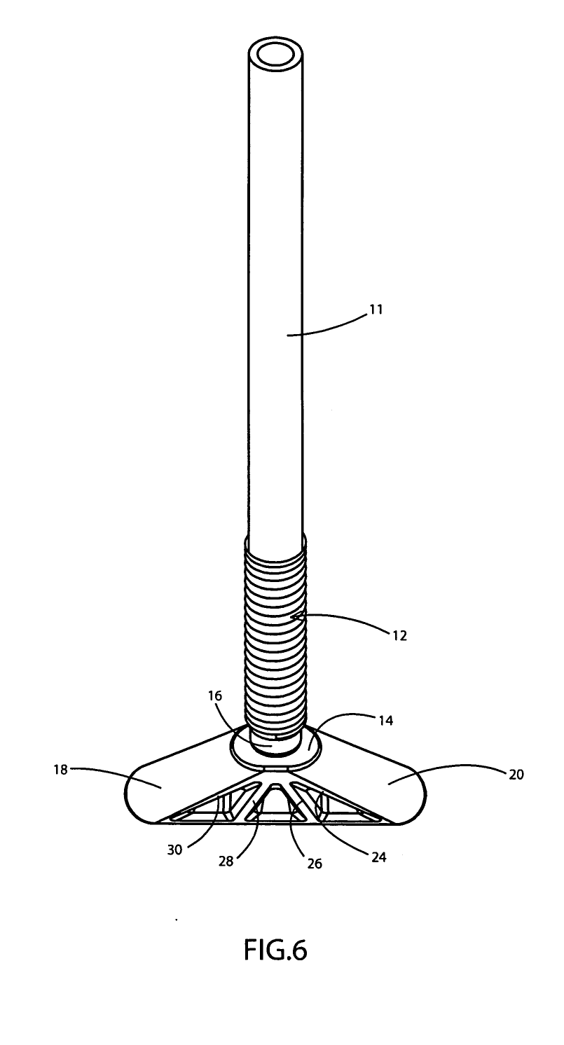

Referring to FIGS. 1-8, there is shown a steamer head in accordance with the present invention and generally indicated at 10. Steamer head 10 is adapted to be used as part of a steaming system for cleaning and/or smoothing fabric surfaces such as carpeting or cloth used in drapes, furniture or clothing. Steamer head 10 comprises a housing that includes a rear wall 14, an inlet 16 extending outwardly and rearwardly from rear wall 14, and a pair of side walls 18, 20 that extend outwardly and forwardly from rear wall 14. Side walls 18, 20 are disposed at an acute angle to each other and terminate in an applicator face 22. Applicator face 22 preferably is substantially parallel to rear wall 14 and is disposed at right angles to the longitudinal axis A-A of head 10. Steamer head 10 is connected via a pipe or hose 11 to a reservoir (not shown) and a spring region 12 extends between inlet 16 and hose 11 to offer flexible stability to hose 11. Hose 11 feeds steam from the remote reservoir to head 10. Steamer head 10 may be manufactured from any suitable material that is able to withstand the exposure to water and to the temperatures involved. Suitable materials are aluminum or plastic and steamer head may be made entirely from one or the other of these materials or may be made as a combination of the two.

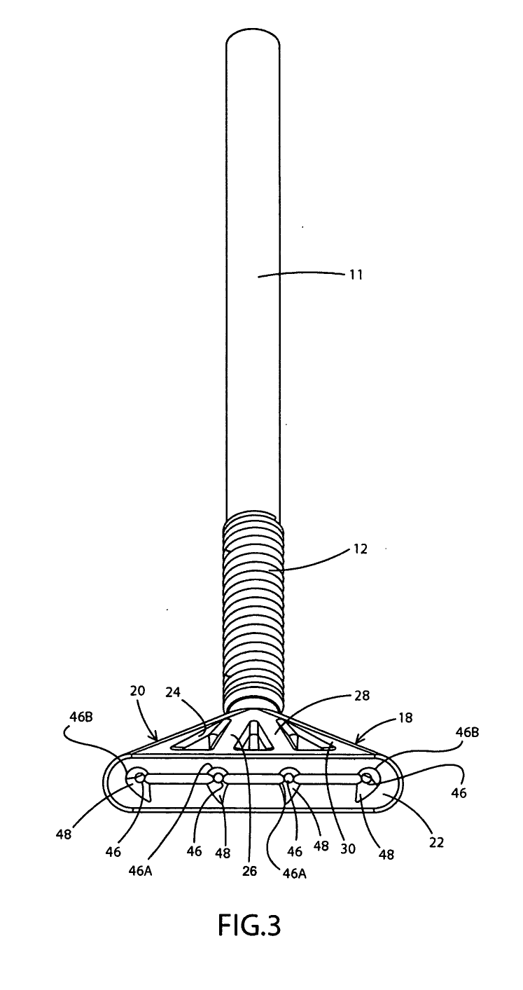

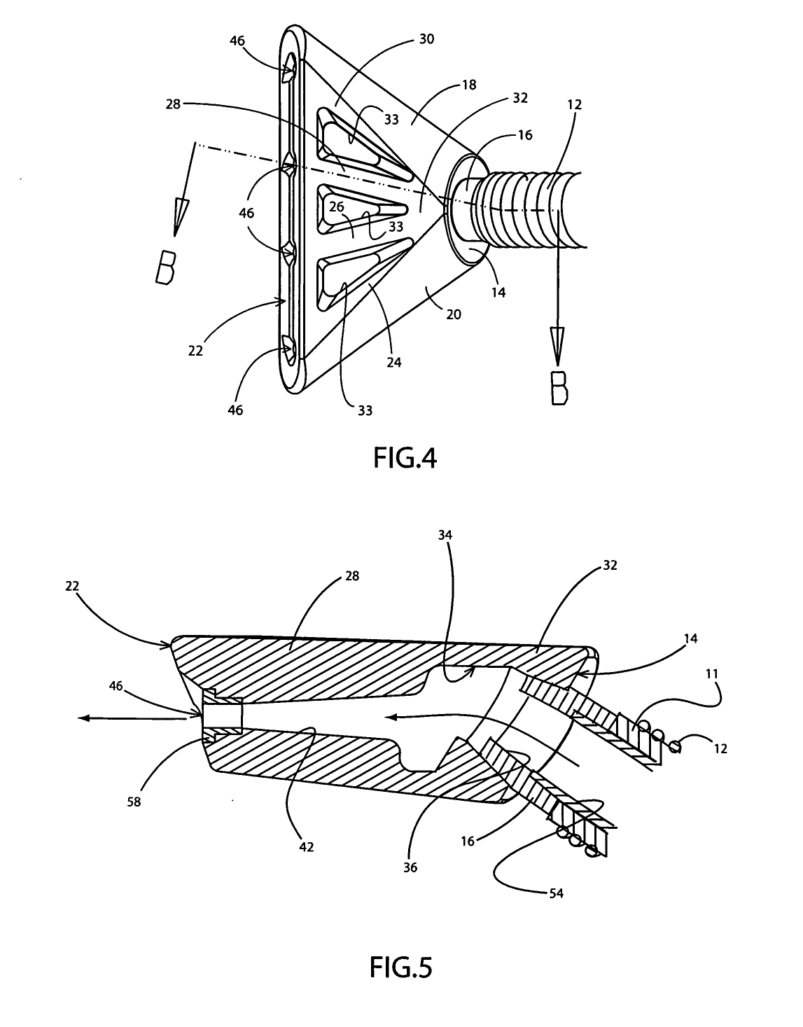

In accordance with a specific feature of the present invention, housing 14 further includes a plurality of branches 24, 26, 28, 30 (FIG. 3) that originate in a base region 32 proximate rear wall 14 and terminate proximate applicator face 22. Branches 24, 26, 28, 30 fan outwardly away from base region 32 and adjacent branches are separated from each other by substantially triangularly shaped gaps 33 (FIG. 4). An interior cavity 34 is formed in base region 32 and cavity 34 is continuous with the bore 36 of inlet 16. Each branch 24, 26, 28, 30 has an interior chamber 38, 40, 42, 44, (FIG. 8) that is continuous with cavity 34 and terminates in an aperture or outlet 46 in applicator face 22. Outlets 46 include inner outlets 46A and outer outlets 46B. Each of chambers 38, 40, 42 and 44 within branches 24, 26, 28, 30 preferably is oriented so it terminates at an angle other than ninety degrees to applicator face 22. This allows steam to be delivered out of outlets 46 in steamer head 10 in a fan-shaped pattern. However, it will be understood that one or more of chambers 38, 40, 42 and 44 may be oriented to terminate substantially at right angles to applicator face 22 without departing from the spirit of the present invention.

Chambers 38, 40, 42 and 44 may be formed so that they are substantially identical in shape and size. Alternatively, one or more of chambers 38, 40, 42, 44 may be formed to be of a different size and shape to one or more of the other chambers. These differences will cause different rates and volumes of steam to be delivered through each the various apertures of outlets 46. So, for example, if a steam head was required to deliver substantially equal rates and volumes of steam through each of outlets 46, then chambers 40, 42 would be formed to be narrower than chambers 38 and 40.

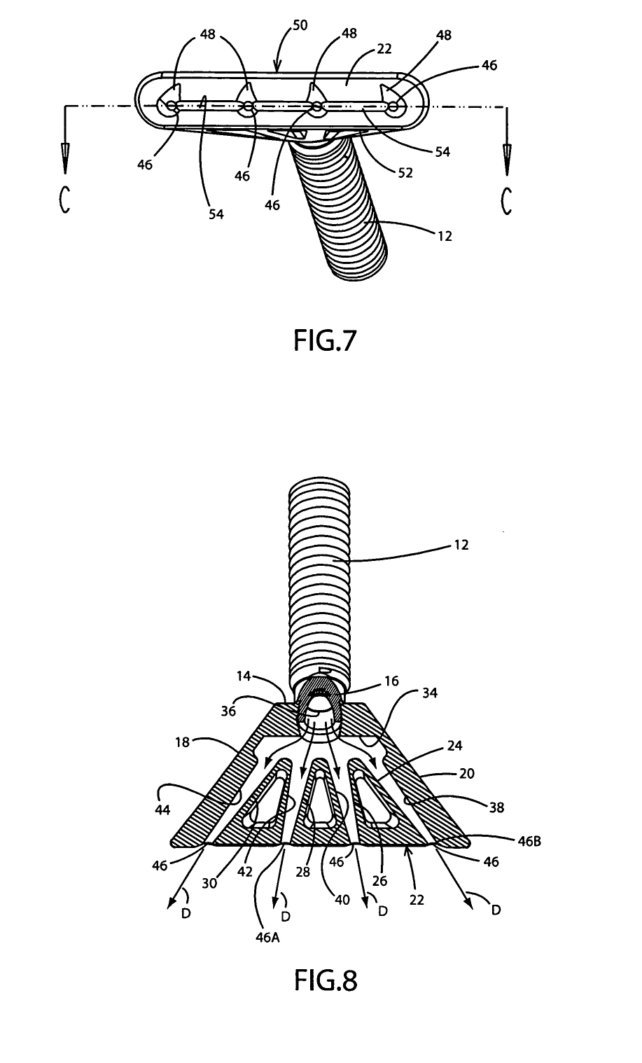

As seen in FIG. 7, teardrop shaped recessed regions 48 are formed in applicator face 22 surrounding each outlet 46. Recessed regions 48 preferably are oriented with a narrower portion proximate an upper surface 50 of head 10 and a wider portion proximate a lower surface 52 of head 10. Recessed regions 48 are connected to each other by channels 54. The shape and position of recessed regions 48 and channels 54, aids in causing steam to be emitted from outlets 46 in a directed manner onto the surface to be cleaned.

A brass nozzle 58 may also be inserted into each outlet 46 to aid in directing the stream “D” (FIG. 8) of steam that is emitted from that outlet 46. Nozzles 58 may be inserted into outlets 46 in any one of a number of different orientations relative to applicator face 22. So, for example, a nozzle 58 may be oriented substantially at right angles to applicator face 22 or may be oriented at an angle other than ninety degrees to applicator face 22.

Steamer head 10 is used in the following manner. Head 10 is connected, via inlet 16, to a hose 11, which in turn is attached to a remote reservoir (not shown). Steam generated in the reservoir travels down the interior bore 54 of hose 11. FIG. 8 illustrates the flow pattern of that steam through the bore 36 of inlet 16 and into interior cavity 34 in head 10. The steam then flows out of interior cavity 34, through chambers 38, 40, 42, 44 and out of the outlets 46 in applicator face 22. The angular orientation of branches 24, 26, 28, 30, relative to base region 32 and to each other, preferably causes the streams “D” of steam exiting outlets 46 to fan out relative to each other. The stream of steam exiting from each outlet 46 preferably tends to be oriented at an angle other than 90° relative to applicator face 22. Consequently, the plurality of streams of steam emitted from head 10 spread outwardly away from applicator face 22 in a fan-shaped pattern. Steam is therefore delivered from steam head 10 in a more evenly distributed fashion than was the case in previously known steamer heads. Furthermore, the steam emitted from outlets 46 fans outwardly away from applicator face 22. These features make it easier and quicker for a professional cleaner to clean or smooth a fabric surface with steamer head 10 without unnecessarily overlapping consecutive passes over the surface with the steamer head 10. Thus the time and effort taken to clean or smooth a fabric surface is substantially reduced.

It will be understood that nozzles 58 can be inserted into outlets 46 in a manner that will create an alternative steam pattern exiting from steamer head 10.

It will be understood that while branches 24, 26, 28 and 30 are shown to be formed as substantially rigid members of steamer head 10, these branches may also be formed from flexible tubes that originate in base region 32 and terminate in applicator face 22.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A steamer head for use with a steaming system for cleaning and smoothing fabric surfaces, said system including a steam-containing reservoir with a hose extending outwardly therefrom; said steamer head comprising:
a housing having a rear wall, side walls and a front applicator face that is adapted to engage a surface to be steamed;
an inlet provided in the rear wall; said inlet including a bore that is adapted to be operationally connected to a bore within the hose and to thereby receive steam from the reservoir therethrough;
a plurality of spaced-apart outlets formed in the front applicator face of the housing;
a plurality of branches; each branch originating proximate the rear wall of the housing and terminating proximate the front applicator face thereof;
a chamber formed in each of the branches; a first end of each chamber being operationally connected to the bore of the inlet and a second end of each chamber terminating in one of the outlets in the front applicator face; whereby steam introduced into the bore of the inlet is able to travel through the chambers of the branches and exit the housing through the outlets in the front applicator face.

2. The steamer head as defined in claim 1, wherein the branches are oriented in a fan-shaped pattern relative to the rear wall of the housing.

3. The steamer head as defined in claim 2, wherein at least one of the branches terminates proximate the front applicator face at an angle other than ninety degrees thereto; whereby the chamber in the at least one branch terminates in the front applicator face at an angle other than ninety degrees thereto.

4. The steamer head as defined in claim 2, wherein the housing includes a base region proximate the rear wall thereof; and the plurality of branches originate in the base region.

5. The steamer head as defined in claim 4, wherein the base region includes an interior cavity that is operationally connected to the bore of the inlet; and wherein the chambers of the branches are operationally connected to the interior cavity in the base region.

6. The steamer head as defined in claim 5, wherein adjacent branches that originate in the base region are oriented at an angle relative to each other.

7. The steamer head as defined in claim 6, wherein adjacent branches are separated from each other by a gap.

8. The steamer head as defined in claim 1, wherein the chambers of the branches are substantially identical in size and shape.

9. The steamer head as defined in claim 1, wherein the chambers of the branches differ in size and shape relative to each other.

10. The steamer head as defined in claim 1, further comprising a nozzle inserted into each of the outlets in the front applicator face.

11. The steamer head as defined in claim 10, wherein an outermost end of each of the nozzles is disposed substantially flush with the front applicator face.

12. The steamer head as defined in claim 10, wherein an outermost end of each of the nozzles protrudes forwardly from the front applicator face.

13. The steamer head as defined in claim 10, wherein at least one nozzle is oriented at an angle other than ninety degrees to the front applicator face.

14. The steamer head as defined in claim 10, wherein the nozzles are manufactured from brass.

15. The steamer head as defined in claim 1, wherein the front applicator face includes a plurality of recessed regions, each of the recessed regions surrounding one of the outlets in the front applicator face.

16. The steamer head as defined in claim 15, wherein each recessed region is substantially tear-dropped in shape.

17. The steamer head as defined in claim 16, wherein a narrower portion of each of the tear-dropped shaped regions is oriented proximate a first end surface of the front applicator face; and a wider portion of each of the tear-dropped shaped regions is oriented proximate a second end surface of the front applicator face.

18. The steamer head as defined in claim 15, further comprising a plurality of grooves formed in the front applicator face, each groove connecting adjacent recessed areas together.

19. The steamer head as defined in claim 1, wherein the housing is manufactured from cast aluminum.

20. The steamer head as defined in claim 19, wherein the housing is manufactured from at least one of aluminum and plastic.
